(19) United States
(12) Patent Application Publication
(10) Pub. No.: US 2013/0091011 A1
(43) Pub. Date: Apr. 11, 2013

(54) CATEGORY RECOMMENDATION METHODS AND SYSTEMS

(71) Applicant: JOHN DAVID YOUNG, III, OVERLAND PARK, KS (US)

(72) Inventor: JOHN DAVID YOUNG, III, OVERLAND PARK, KS (US)

(73) Assignee: ADKNOWLEDGE, INC., KANSAS CITY, MO (US)

(21) Appl. No.: 13/435,743

(22) Filed: Mar. 30, 2012

Related U.S. Application Data
(60) Provisional application No. 61/469,196, filed on Mar. 30, 2011.
(60) Provisional application No. 61/469,611, filed on Mar. 30, 2011.

(51) Int. Cl. G06Q 30/02

(52) U.S. Cl. CPC G06Q 30/0275
USPC 705/14.45

(57) ABSTRACT

Methods and systems provide suggestions for additional categories (and also keywords, phrases, etc.), for advertisers and information providers, and publishers, to bid on, based on conditional probabilities. The conditional probabilities are based on consumer conversions at target web sites of advertisers and information providers, associated with a category, keyword, phrase etc. The category suggestions are subject to a further trimming process, before being recommended to the advertisers and information providers, and publishers.

### CROSS-REFERENCES TO RELATED APPLICATIONS

This patent application is related to and claims priority from commonly owned U.S. Provisional Patent Application Ser. No. 61/469,196, entitled: Advertiser Category Recommendation System, filed on Mar. 30, 2011, and commonly owned U.S. Provisional Patent Application Ser. No. 61/469,611, entitled: Publisher Category Recommendation Engine, filed on Mar. 30, 2011, the disclosures of which are incorporated by reference in their entirety herein.

### FIELD OF THE INVENTION

The present invention relates to methods systems for recommending categories for use by advertisers, publishers and other information providers.

### BACKGROUND OF THE INVENTION

Advertising over the Internet continues to grow, and more businesses are allocating increasing financial resources to attract consumers over the Internet. One type of advertising is known as pay per click or price per click (PPC) or cost per click (CPC) where advertisers bid for a keyword, category or the like. When the advertiser's ad, for example, as a graphic, or listing, for example, as typically listed on a search results web page, is selected by a consumer, for example, by making a click on the advertisement, graphic, link therefore, or representations thereof, or other designated graphic, the advertiser is charged the bid amount for the click. The consumer's browsing application on their computer is directed over the network, e.g., the Internet, to a target web site associated with the advertiser, whose bid was accepted and whose account was charged or debited for the click.

### SUMMARY OF THE INVENTION

The present invention improves on the providing of advertiser listings for a single keyword or category, by providing methods and systems for alerting advertisers and information providers to additional categories, keywords, etc, which they should bid on. This is based on the performance of the categories, keywords and the like, for which these advertisers and information providers presently have bids on in the advertising or information providing system.

The present invention improves on the providing of advertiser listings for a single keyword or category, by providing methods and systems for alerting publishers providers to additional categories, keywords, etc, which they should bid on. This is based on the performance of the categories, keywords and the like, for which these publishers presently have bids on in the advertising or information providing system.

Embodiments of the invention are directed to methods and systems which provide suggestions for additional categories (and also keywords, phrases, etc.), for advertisers and/or information providers, and publishers, to bid on, based on conditional probabilities. The conditional probabilities are based on consumer conversions at target web sites of advertisers and information providers, associated with a category, keyword, phrase etc. The category suggestions are subject to a further trimming process, before being recommended to the advertisers and information providers, and publishers.

Another embodiment of the invention is directed to a method (process) for providing system users (e.g., advertisers or information providers) with additional categories (also keywords, phrases, etc.) on which to bid on, over a communications network (such as the Internet). The method includes, for example, monitoring, by a computer system (for example, the computer system formed of one or more servers and/or other computer components, processors, storage media, and the like), linked to the communications network, target web sites, each of the target web sites associated with a category and a system user, and hosted by a host computer device (e.g., one or more servers), each host computer device linked to the communications network, for indications of consumer actions at the target web sites (e.g., conversions, resulting from clicks by consumers on a designated web page of the target web site to which the consumer's browser was directed, when the consumer clicked on, or otherwise responded to, an impression (typically in an electronic communication), served to his computer over the communications network), over the communications network; obtaining, by the computer system, data associated with the indications of consumer action at the target web sites, over the communications network; determining, by the computer system, the probability of indications of consumer action at one category given indications of consumer actions at another category, based on the obtained data associated with the indications of consumer actions at the target web sites; and, selecting, by the computer system, one or more additional categories for at least one system user, based on the determined probabilities (for example, conditional probabilities), and determining if the one or more additional categories is to be recommended for the at least one system user to bid on.

The method is also such that, for example, the obtaining data associated with the indications of consumer action at the target web sites is performed automatically and for a predetermined time period. Additionally, for example, the computer system electronically notifies the computer of a system user of one or more additional categories which are recommended for the at least one system user to bid on, over the network.

Another embodiment of the invention is directed to a system for providing system users (e.g., advertisers and information providers) with additional categories on which to bid on, over a communications network. The system includes, for example, a computer device (for example, one or more servers) linked to the communications network, and an engine in communication with the computer device. The computer device is configured, for example, for monitoring target web sites, each of the target web sites associated with a category and a system user, and hosted by a host computer device (for example, one or more servers), each host computer device linked to the communications network, for indications of consumer actions (e.g., conversions) at the target web sites, over the communications network; obtaining data associated with the indications of consumer action at the target web sites, over the communications network; and, determining the probability of indications of consumer action at one category given indications of consumer actions at another category, based on the obtained data associated with the indications of consumer actions at the target web sites. The engine is configured for selecting one or more additional categories for at least one system user, based on the determined probabilities, and determining if the one or more additional categories is to be recommended for the at least one system user to bid on.

Another embodiment of the invention is directed to a method (process) for providing publisher users (e.g., also publishers or sources) with additional categories (also, keywords, phrases, etc.) on which to bid on, over a communications network (e.g., the Internet). The method includes, for example, monitoring, by a computer system (for example, the computer system formed of one or more servers and/or other computer components, processors, storage media, and the like), linked to the communications network, target web sites, each of the target web sites associated with a category, and hosted by a host computer device (such as one or more servers), each host computer device linked to the communications network, for indications of consumer actions at the target web sites (e.g., conversions), over the communications network; obtaining, by the computer system, data associated with the indications of consumer action at the target web sites, over the communications network; determining, by the computer system, the probability (e.g., conditional probability) of indications of consumer action at one category given indications of consumer actions at another category, based on the obtained data associated with the indications of consumer actions at the target web sites; and, selecting, by the computer system, one or more additional categories for at least one publisher user, based on the determined probabilities, and determining if the one or more additional categories is to be recommended for the at least one publisher user to bid on.

The method is such that, for example, the obtaining data associated with the indications of consumer action at the target web sites is performed automatically and for a predetermined time period. Additionally, for example, selecting of the additional categories is based on effective costs per mille (eCPM) values (e.g., cost for serving 1000 impressions to consumers). The computer system electronically notifies a computer device of a publisher user of one or more additional categories which are recommended for the at least one publisher user to bid on, over the network.

This document references terms that are used consistently or interchangeably herein. These terms, including variations thereof, are as follows.

The term “click”, “clicks”, “click on”, “clicks on” involves the activation of a computer pointing apparatus, such as a device commonly known as a mouse, on a location on a computer screen display that causes an action of the various software and or hardware supporting the computer screen display.

A “web site” is a related collection of World Wide Web (WWW) files that includes a beginning file or “web page” called a home page, and typically, additional files or “web pages”. The term “web site” is used collectively to include “web site” and “web page(s)”.

A uniform resource locator (URL) is the unique address for a file, such as a web site or a web page that is accessible on the Internet.

A “creative” is an electronic communication, typically an advertising communication that includes images and text within the image, and a link for the URL of a targeted web site, associated with the owner or other controlling party of the electronic communication. When the link is activated, typically by the user clicking on a box that overlies the link, the user's browser obtains the URL of the targeted web site associated with the owner or other controlling party, of the electronic communication, and is directed to the targeted web site, associated with the uniform resource locator (URL) of the link and the party who controls the electronic communication.

A “conversion” is an action taken by the user on the web page that his browser has been directed to, such as a click on the web page, whereby the user can, for example, request additional information, sign up for a service, or make a purchase, etc.

A server is typically a remote computer or computer device, or remote computer system, or computer program therein, that is accessible over a communications medium, such as the Internet, that provides services to other computer programs (and their users), in the same or other computers.

An “engine” is a program or algorithm, which performs a core or essential function for other programs. An engine can be a central or focal program in an operating system, subsystem, or application program that coordinates the overall operation of other programs. It is also used to describe a special-purpose program containing an algorithm that can sometimes be changed.

“Banners” are graphic images that overlay a displayed web page. Banners are commonly in the form of pop-ups, buttons, roll-ups, and other similar on-screen displayed graphics.

“n” and “nth” indicate the last members of a finite series or a potentially changing series, the series including one or more members, devices, etc.

### BRIEF DESCRIPTION OF DRAWINGS

Attention is now directed to the drawing figures, where like numerals or characters indicate corresponding or like components. In the drawings:

FIG. 1 is a diagram of an environment that supports an embodiment of the invention;

FIG. 2 is a diagram of a taxonomy in accordance with the embodiment of the invention;

FIG. 3 is a flow diagram of a process (method) performed in accordance with the embodiment of the invention;

FIG. 4 is the diagram of FIG. 1 illustrating operation of the embodiment of the invention;

FIG. 5 is a diagram showing the conversions database of the system of the embodiment of the invention in detail; and,

FIG. 6 is a flow diagram of a process (method) performed in accordance with an alternate embodiment of the invention.

Appendix A is attached to this document, entitled: Conditional probability (seven pages total, eight pages total with the cover page), and is available at http://en.wikipedia.org/wiki/Conditional_probability.

Appendix B is attached to this document, entitled: Item-Item User Interest Score.

### DETAILED DESCRIPTION

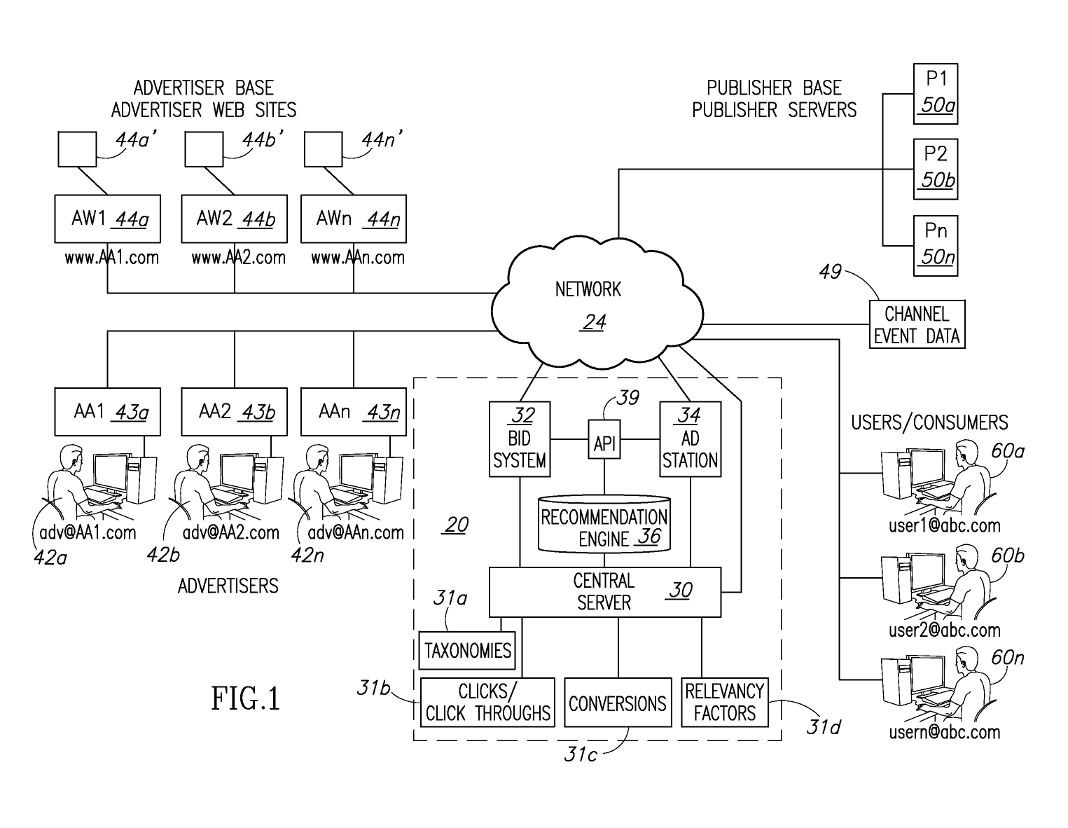

FIG. 1 shows a system 20 that performs the present invention, in a typical environment. The system 20 is linked to and in communication with various other systems, components, computers, computer devices and the like (such as those detailed herein), directly and indirectly, via a network 24 or communications network, for example, a computer network, a wide area network (WAN), or public network, for example, the Internet. The system 20 is formed of a central server 30, also known as a main server, along with an advertiser system 32 and a publisher system 34, all linked and in communication with, directly or indirectly, each other and the network 24. The system 20, and the central server 30 are also associated with various components, processors, modules, engines, computer devices, storage media, databases, caches and the like.

The central server 30 includes one or more processors, and is constructed and arranged similar to the home servers described in commonly owned U.S. patent application Ser. No. 10/915,975 (U.S. Patent Application Publication No. U.S. 2005/0038861 A1) and commonly owned U.S. patent application Ser. No. 11/774,106 (U.S. Patent Application Publication No. U.S. 2008/0098075 A1), both of the disclosures of which are incorporated by reference in their entirety herein. The central server 30 stores various creatives for e-mail or other electronic communications, as well as banners for communication over web channels.

The central server 30 may be one or more servers, computers, computer devices and the like. It may include or be associated with various components (including computer components), processors, modules, engines, computer devices, storage media, databases, caches and the like, which are operable with each other. The processors are capable of executing the various components in order to perform the processes detailed below. For example, databases associated with the central server, include those for taxonomies 31a, clicks/click through 31b, conversions 31c, relevancy factors 31d, but may include numerous other databases, caches, storage media, and the like, in addition to the storage provided by the central server 30.

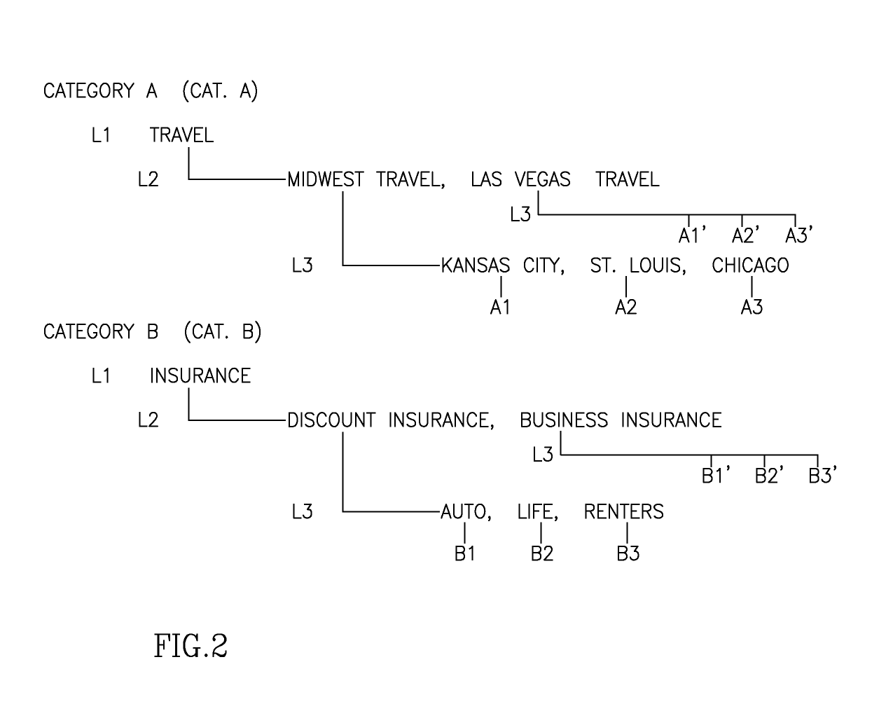

The central server 30 also maintains a taxonomy of categories, as shown in FIG. 2, for example, in the taxonomy database 31a. Each of the categories is associated with one or more creatives. In FIG. 2, the categories (Category A (CAT A), for example “Travel” at Level 1 (L1), and Category B (CAT B), for example, “Insurance” at Level 1 (L1)) may be further broken down into subjects, key words and the like. For example, Level 2 (L2) categories for the Primary category “TRAVEL” are “MIDWEST TRAVEL,” “LAS VEGAS TRAVEL.” “MIDWEST TRAVEL” has the L3 or “user level” categories of A1-“KANSAS CITY,” A2-“ST. LOUIS,” and A3-“CHICAGO.” For example, Level 2 (L2) categories for the Primary category “INSURANCE” of Category B, are “DISCOUNT INSURANCE” and “BUSINESS INSURANCE.” “DISCOUNT INSURANCE” has the L3 or “user level” categories of B1-“AUTO,” B2-“LIFE, and B3-“RENTERS.” These taxonomies are discussed further below.

The central server 30, for example, maintains and administers the creatives in a manner similar to that as described in commonly owned U.S. patent application Ser. No. 11/774,106. The central server 30 also includes e-mail functionalities, as well as banner and web functionalities and provides for account maintenance and administration, monitoring and tracking of clicks. The central server 30 may interact with an imaging server, such as that disclosed in U.S. patent applications Ser. Nos. 10/915,975 and 11/774,106, for converting text (e.g., data in text format, including such data obtained from listings) into images for placement into opened electronic communications and opened e-mails as detailed in commonly owned U.S. patent Ser. No. 10/915,975).

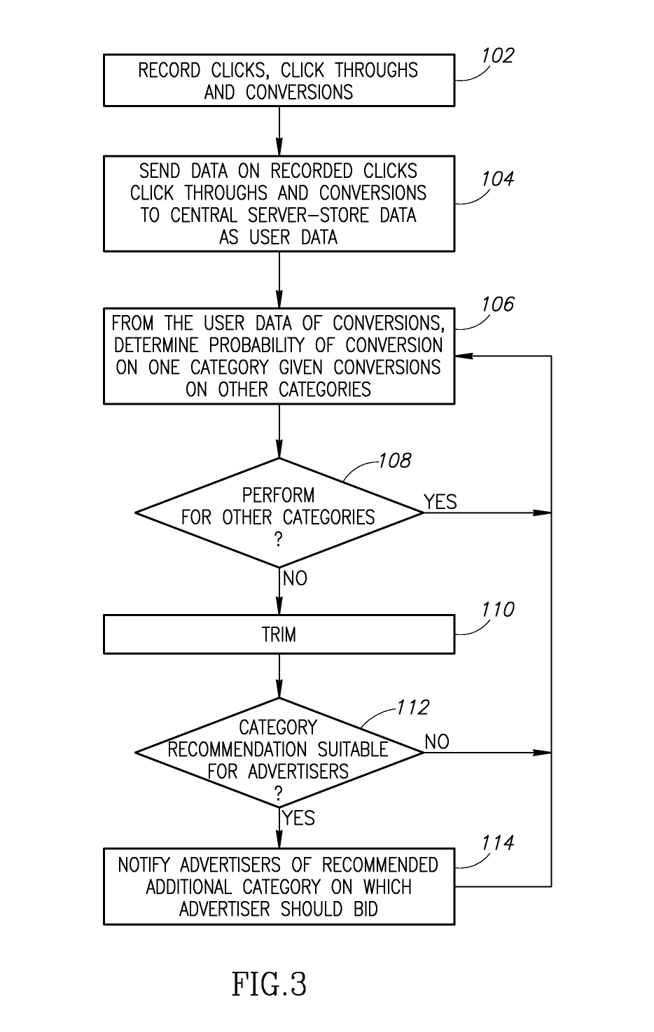

The system 20 includes an advertiser system 32 or “BID SYSTEM”, as disclosed in commonly owned U.S. patent application Ser. No. 10/256,871 (U.S. Patent Application Publication No. U.S. 2006/0248110 A1), the disclosure of which is incorporated by reference in its entirety herein. The advertiser system 32 is linked to the network 24 and is designed to interface with the central server 20 and advertisers 42a-42n (also known as advertiser users, advertising users, system users, and users, with respect to the computer system 20), represented by corresponding Advertiser Servers (AA1-AAn) 43a-43n, such that advertiser bids for keywords, categories, subjects, and the like, are monitored, administered and advertiser accounts are maintained by the system 32, as well as advertiser host servers (AW1-AWn) 44a-44n, that host advertiser web sites and web pages 44a′-44n′, these web pages supporting tracking pixels (47a FIG. 3), used in monitoring, tracking and recording conversions at the advertiser's web site/web page. For example, Advertiser Server AA1 43a is typically associated with advertiser host server AW1 44a, Advertiser Server AA2 43b is typically associated with advertiser host server AW2 44b, etc.

The system 20 includes a publisher system 34 or “AD STATION,” linked to the network 24 and which is designed to interface with the central server 30 and publishers, represented by publisher servers (P1-Pn) 50a-50n. This system is programmed to pull categories with an associated creative, and send them to the desired publishers (also known as publisher users or sources)/publisher servers 50a (the publisher servers 50a-50n are representative of multitudes of publisher servers). At each publisher server 50a, the creative is placed into an electronic communication, such as e-mail and sent to users (also known as consumers) 60a-60n (whose e-mail address is stored and maintained by the publisher server 50) over a consumer channel 64. Each publisher server 50a-50n maintains the address of the e-mail recipient and handles the sending operation of the e-mail, in accordance with that described in commonly owned U.S. patent application Ser. No. 11/774,106. The sent e-mail (to the e-mail client) associated with the computer and the user is in accordance with the e-mail as detailed in U.S. patent application Ser. No. 10/915,975 or U.S. patent application Ser. No. 11/774,106. Upon the e-mail being opened, it is processed as content is provided thereto, by the central server 30, in accordance with the content providing procedures detailed in U.S. patent application Ser. No. 10/915,975 or U.S. patent application Ser. No. 11/774,106. Clicking on the content will direct the browsing application of the computer associated with the user or consumer to the URL if the target web site (whereby the user lands on a web page of the target web site).

The recommendation engine 36 is linked to the central server 30 and is designed to provide advertisers 42a-42n with additional options for improving yield, and is also known as an advertiser category recommendation engine. The recommendation engine 36 uses an item-to-item collaborative filter to generate high yielding category options for any advertiser (represented by the advertiser base). Other important components of the engine 36 are Advertiser Bids (from the Advertiser System 32), clicks and conversions.

An application program interface (API 39) serves as an interface between the recommendation engine 36 and clients of the advertiser system 32, and clients of the publisher system 34. The clients provide access to the recognition engine 36 for the advertiser system 32 and the publisher system 34, and the clients make requests to the API 39, for example, via a “GET Statement,” to the recognition engine 36 with a unique identifier, for example, an Advertiser ID (identifier). The API 39 is programmed to instruct the recommendation engine to pull all category recommendations for this unique identifier, with the API 39 pushing back all corresponding recommendations for the specific identifier.

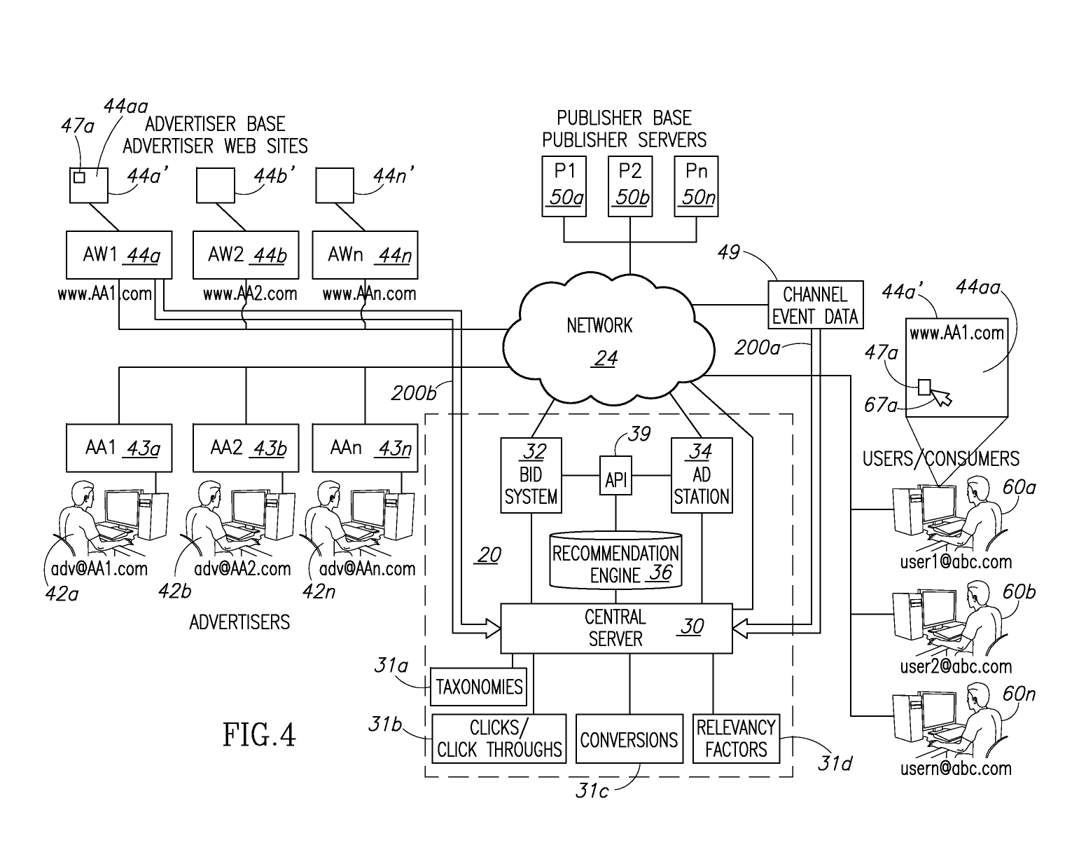

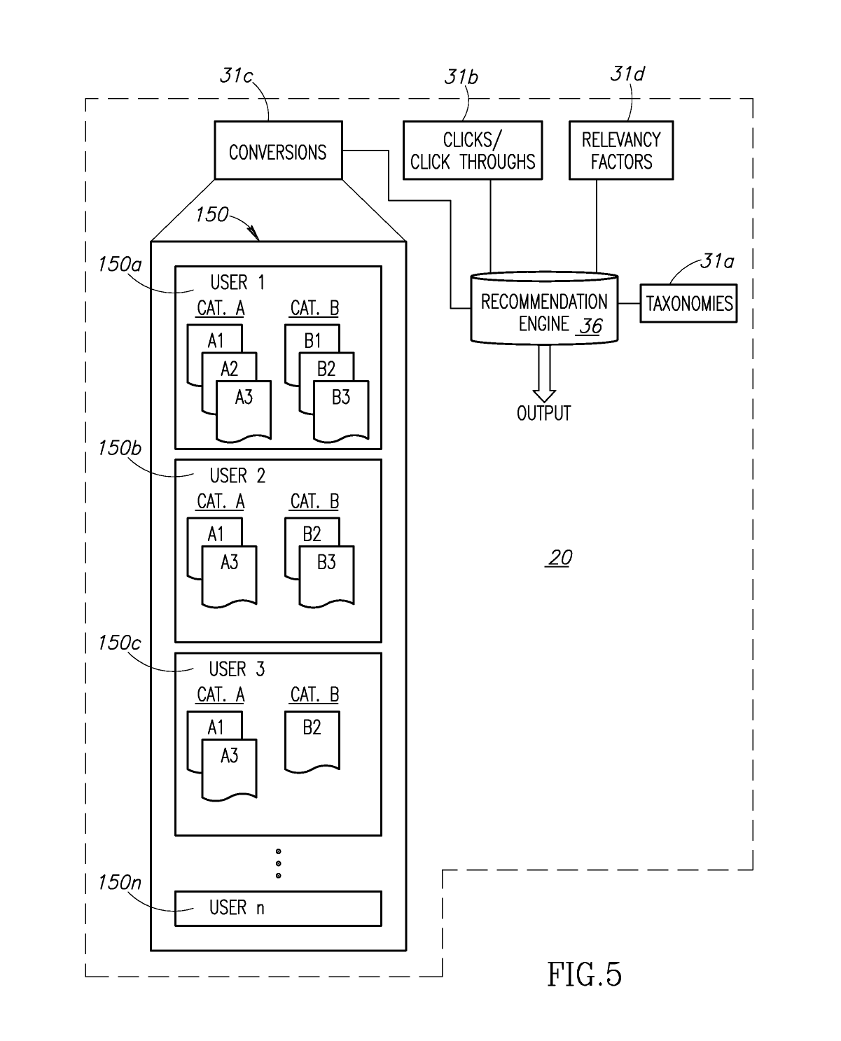

Attention is also directed to FIG. 3, a flow diagram detailing a process performed by the system 20, in particular, by the central server 30 and recognition engine 36. The process can be performed for one or more advertisers, and can run for the advertisers in the system 20 simultaneously and/or contemporaneously. The processes detailed in the flow diagram are typically performed automatically. FIGS. 4 and 5 are also discussed when discussion the flow diagram.

Initially, at block 102, the central server 30 records clicks, and click throughs, and conversions. The process moves to block 104.

At block 104, the data for these recorded clicks, click throughs and conversions is sent to the central server 30, typically automatically, where for example, data for clicks and click throughs is recorded and stored in database 31b, and data for conversions, for example, is recorded and stored in the database 31c. The stored data may represent data obtained recorded over or for a predetermined time period, so as to have a suitable sample size.

As shown in FIG. 4, to which attention is also directed, the clicks and click thoughts come from the publishers from the channel events server 49, for the particular channel, e.g, e-mail, banners, etc. The corresponding data for the clicks and click throughs is sent from the channel events server 49 to the central server 36 over the network 24, as represented by the arrow 200a.

The corresponding data for a conversion, is obtained, for example via a tracking pixel 47a, placed on a web page 44aa of a target web site, for example site 44a′, hosted by server AW1 44a, this web page 44aa corresponding to the advertiser AA1, with the web site 44a having the address, for example www.AA1.com. The tracking pixel 47a is activated by a user, for example, user 60a, whose address is user1@abc.com, clicking (arrow 67a) on the web page 44aa at the target web site 44a′, for example, www.AA1.com. The data for the tracking pixel 47a being activated on the web page 44aa, is sent to the central server 30 over the network 24, as represented by the arrow 200b, as advertiser servers AW1-AWn are, for example, mapped to the system 20, in particular, the central server 30, via the Advertiser System 32.

This stored data of clicks and click throughs, and conversions, is stored in the respective databases 31b, 31c as user data. This also occurs at block 104.

The process moves to block 106, where conditional probabilities are determined from the user data. Turning also to FIG. 5, conditional probabilities are, for example, based on conversions. The conversions are recorded and stored in the database 31c, and include user records 150, as shown in FIG. 5 Referring also to the taxonomy of FIG. 2 and the user records of FIG. 5, user 1 60a (user1@abc.com) (record 150a) has converted on Category A at Level 3 on A1-“KANSAS CITY,” A2-“ST. LOUIS,” and A3-“CHICAGO.” User 1 60a has also converted on Category B at Level 3, on B1-“AUTO”, B2-“LIFE” and B3-“RENTERS.” User 2 60b (user2@abc.com) (record 150b) has converted on Category A at A1-“KANSAS CITY,” and A3-“CHICAGO.” User 2 has converted on Category B at B2-“LIFE” and B3-“RENTERS.” The same system holds true for user 3 (record 150c) through user n (record 150n). The conditional probabilities are generated, for example, in accordance with the document entitled: Conditional Probability, attached to this document as Appendix A, and available at http://en.wikipedia.org/wiki/Conditional_probability. Conditional probabilities may also be generated from clicks/click thoughts in the same manner, as detailed above.

The process moves to block 108, where it is determined if more conditional probabilities need to be determined for additional categories. If yes, the process returns to block 106. If no, the process moves to block 110, where a trimming process begins on the best candidates for conversion given a first category has been converted, based on the probabilities detailed above.

At block 110, the trimming process begins as category level bid's (from Level L3) are taken post-auction from each advertiser (represented by the advertiser base 42a-42n) and multiplied by the number of clicks generated from the auction. Bids based on click estimates are then taken into account and divided by the total number of conversions calculated for each advertiser to generate an effective CPA, or eCPA (CPA is cost per action or cost per click). From there, a decay function is used to determine “advertiser interest” based upon consumer response data.

Finally, all the three components are combined together to generate an estimated eCPA at the advertiser, category level and then ranked in descending order for each advertiser ID.

$$( eCPA = {\sum }_{i = 1}^{n} \frac{Bid * Click}{Conversion} )$$

where,

“Bid” is a bid amount made by an advertiser, information provider, also known as a system user, which will be paid for a click on their corresponding impression (as defined herein);

“Click” is defined above; and

“Conversion” is also defined above.

Categories with the highest probability of generating an event (i.e., click, conversion, depending on if clicks or conversions are being analyzed) are disseminated from the recommendation engine 36 and listed in the API 39, for access by advertisers and/or information providers, who select a category, if desired.

In the API 39, recommendations are published for each advertiser (or information provider) at the category level and ranked by eCPA, for example, in ascending order. Accordingly, the category at level L3 with the lowest eCPA and the highest probability of generating the largest amount of clicks appears first (is listed first).

It is determined, at block 112, if the category recommendations are suitable for the advertisers, at block 112. This is achieved by the processor of the central server 30, applying a program of instructions to determine if the eCPA meets a threshold eCPA of the system 20 (in the central server 30 or storage media thereof or associated therewith), for example, as programmed into the system 20 by a system administrator or other entity (including electronic entities) with access to the system 20 and the central server 30.

If not suitable, for example, the category's eCPA, or categories respective eCPAs, do not meet the threshold, the process returns to block 106.

However, if suitable, for example, the category's eCPA, or categories respective eCPAs, meet or exceed the threshold, the process moves to block 114, where the system 20, for example, the processor of the central server 30, notifies the requisite advertisers (for example, represented by advertisers 42a-42n in FIGS. 1 and 4) for the category, that there are additional categories on which the system 20, e.g., the engine 36, recommends these advertisers, for the present category, should bid on. This notification typically occurs by an electronic communication, e.g., e-mail, prompt, etc., over the network 24. The advertiser will access the API 39 (for example, via a link in the electronic communication), and accordingly, place bids on the additional category(ies) via the Bid System (as disclosed in U.S. patent application Ser. No. 10/256,871 ) of the Advertiser System 32, over the network 24.

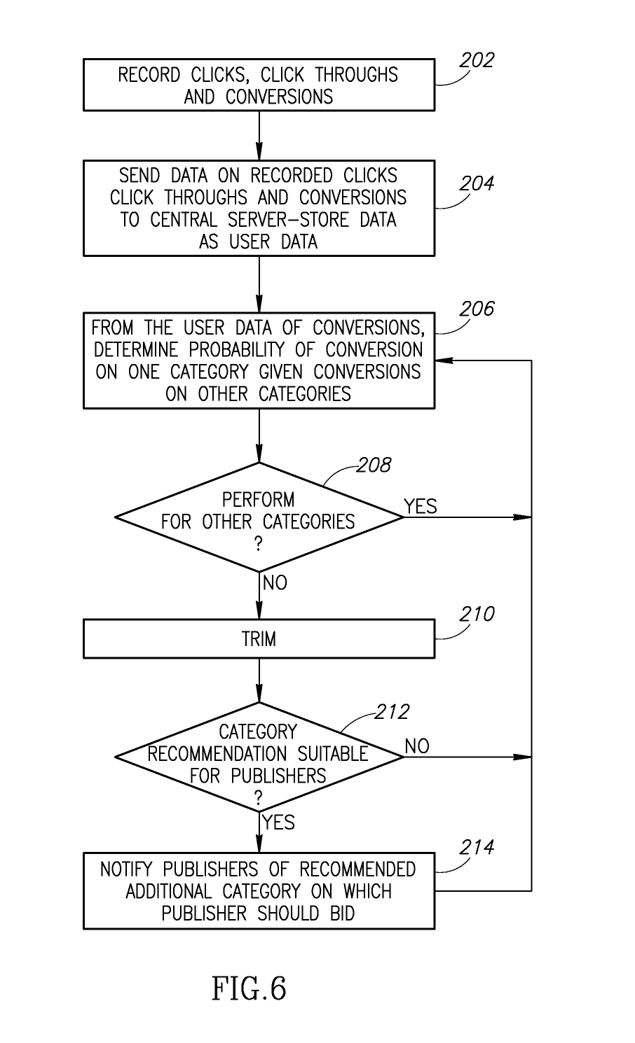

Attention is now directed to FIG. 6, which details an alternate embodiment of the invention, and uses the same system, as shown in FIGS. 1, 2, 4 and 5, as differences are noted below. FIG. 6 s a flow diagram of a process for publisher category recommendations, and centers on the publisher base, represented by publisher servers (P1-Pn) 50a-50n.

Initially, blocks 202, 204, 206 and 208 are similar or identical to and correspond to blocks 102, 104, 106 and 108, respectively, and are in accordance with blocks 102, 104, 106, and 108, as detailed above and shown in FIG. 3. FIGS. 4 and 5 are also applicable here, as described above.

At block 208, where it is determined if more conditional probabilities need to be determined for additional categories. If yes, the process returns to block 206. If no, the process moves to block 210, where a trimming process begins on the best candidates for conversion given a first category has been converted, based on the probabilities detailed above.

At block 210, the trimming process begins as the engine 36 determines a PPC (Price Per Click) and interest score for each category stored in the central server 30. The interest score is determined, for example, as shown in Appendix B, attached to this document. Category level PPC's are estimated for each publisher, and a file is generated. Those PPC's are then taken into account and a score is calculated for each publisher. From there, an exponential decay function is used to determine “publisher interest” based upon consumer click data.

Finally, all the three components are multiplied together to generate an estimated eCPM (effective cost per mille or thousand impressions, an impression typically including a creative, and being an electronic communication such as an e-mail or banner) for the publisher at the category level (L3 of FIG. 2) in accordance with the formula:

eCPM=CTR*PPC*1000

where,

“CTR” is the click through rate—the number of clicks resulting in redirections of a browsing application of a consumer/user (e.g. consumers/users 60a-60n) computer when the consumer clicks on an ad or other graphic (collectively, also known as an impression) on his computer (and served to his computer, typically in or as an electronic communication, such as e-mails and banners), versus the total number of times the ad or other graphic is served to the computer of the consumers/users (e.g., consumers/users 60a-60n), typically taken for a predetermined time period, or for a predetermined number of servings of the impression; and

“PPC” is Price Per Click, as defined herein.

Based on the resultant eCPM, the categories are then ranked in descending order for each publisher. Categories with the highest probability of generating an event (i.e., click) are disseminated from the recommendation engine 36 and listed in the API 39, for access by publishers, who select a category, if desired.

In the API 39, recommendations are published for each publisher at the category level and ranked by eCPM, for example, in ascending order. Accordingly, the category at level L3 with the lowest eCPM and the highest probability of generating the largest amount of clicks appears first (is listed first).

It is determined, at block 212, if the category recommendations are suitable for the publishers, at block 212. This is achieved by the processor of the central server 30, applying a program of instructions to determine if the eCPM meets a threshold eCPM of the system 20 (in the central server 30 or storage media thereof or associated therewith), for example, as programmed into the system 20 by a system administrator or other entity (including electronic entities) with access to the system 20 and the central server 30.

If not suitable, for example, the category's eCPM, or categories respective eCPMs, do not meet the threshold, the process returns to block 206.

However, if suitable, for example, the category's eCPM, or categories respective eCPMs, meet or exceed the threshold, the process moves to block 214, where the system 20, for example, the processor of the central server 30, notifies the requisite publishers (for example, represented by publisher servers 50a-50n in FIGS. 1 and 4) for the category, that there are additional categories on which the system 20, e.g., the engine 36, recommends these publishers, for the present category, should bid on.

This notification typically occurs by an electronic communication, e.g., e-mail, prompt, etc., over the network 24. The publisher will access the API 39 (for example, via a link in the electronic communication), and accordingly, place bids on the additional category(ies) via the Ad Station (as disclosed in U.S. patent application Ser. No. 11/774,106) of the publisher system 34, over the network 24.

The above-described processes including portions thereof can be performed by software, hardware and combinations thereof. These processes and portions thereof can be performed by computers, computer-type devices, workstations, processors, micro-processors, other electronic searching tools and memory and other storage-type devices associated therewith. The processes and portions thereof can also be embodied in programmable storage devices, for example, compact discs (CDs) or other discs including magnetic, optical, etc., readable by a machine or the like, or other computer usable storage media, including magnetic, optical, or semiconductor storage, or other source of non-transient electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

While preferred embodiments of the present invention have been described, so as to enable one of skill in the art to practice the present invention, the preceding description is intended to be exemplary only. It should not be used to limit the scope of the invention, which should be determined by reference to the following claims.

What is claimed is:

1. A method for providing system users with additional categories on which to bid on, over a communications network, comprising:
monitoring, by a computer system, linked to the communications network, target web sites, each of the target web sites associated with a category and a system user, and hosted by a host computer device, each host computer device linked to the communications network, for indications of consumer actions at the target web sites, over the communications network;
obtaining, by the computer system, data associated with the indications of consumer action at the target web sites, over the communications network;
determining, by the computer system, the probability of indications of consumer action at one category given indications of consumer actions at another category, based on the obtained data associated with the indications of consumer actions at the target web sites; and,
selecting, by the computer system, one or more additional categories for at least one system user, based on the determined probabilities, and determining if the one or more additional categories is to be recommended for the at least one system user to bid on.

2. The method of claim 1, wherein the indications of consumer actions at the target web sites include conversions.

3. The method of claim 2, wherein a conversion includes a consumer click on a designated web page of the target web site.

4. The method of claim 2, wherein the obtaining data associated with the indications of consumer action at the target web sites is performed automatically and for a predetermined time period.

5. The method of claim 4, wherein the system user includes an advertiser or an information provider.

6. The method of claim 1, wherein the probability includes a conditional probability.

7. The method of claim 1, wherein selecting the additional categories is based on effective costs per action (eCPA) values.

8. The method of claim 1, wherein the computer system electronically notifies the computer of a system user of one or more additional categories which are recommended for the at least one system user to bid on, over the network.

9. The method of claim 1, wherein the computer system includes at least one server.

10. The method of claim 1, wherein each host computer device includes at least one server.

11. A system for providing system users with additional categories on which to bid on, over a communications network, comprising:
a computer device linked to the communications network, configured for:
monitoring target web sites, each of the target web sites associated with a category and a system user, and hosted by a host computer device, each host computer device linked to the communications network, for indications of consumer actions at the target web sites, over the communications network;
obtaining data associated with the indications of consumer action at the target web sites, over the communications network; and,
determining the probability of indications of consumer action at one category given indications of consumer actions at another category, based on the obtained data associated with the indications of consumer actions at the target web sites; and,
an engine in communication with the computer device configured for selecting one or more additional categories for at least one system user, based on the determined probabilities, and determining if the one or more additional categories is to be recommended for the at least one system user to bid on.

12. The system of claim 11, wherein the computer device includes at least one server.

13. The system of claim 11, wherein the indications of consumer actions at the target web sites include conversions.

14. The system of claim 13, wherein a conversion includes a consumer click on a designated web page of the target web site.

15. A method for providing publisher users with additional categories on which to bid on, over a communications network, comprising:
monitoring, by a computer system, linked to the communications network, target web sites, each of the target web sites associated with a category, and hosted by a host computer device, each host computer device linked to the communications network, for indications of consumer actions at the target web sites, over the communications network;
obtaining, by the computer system, data associated with the indications of consumer action at the target web sites, over the communications network;
determining, by the computer system, the probability of indications of consumer action at one category given indications of consumer actions at another category, based on the obtained data associated with the indications of consumer actions at the target web sites; and,
selecting, by the computer system, one or more additional categories for at least one publisher user, based on the determined probabilities, and determining if the one or more additional categories is to be recommended for the at least one publisher user to bid on.

16. The method of claim 15, wherein the indications of consumer actions at the target web sites include conversions.

17. The method of claim 16, wherein a conversion includes a consumer click on a designated web page of the target web site.

18. The method of claim 15, wherein the obtaining data associated with the indications of consumer action at the target web sites is performed automatically and for a predetermined time period.

19. The method of claim 16, wherein the probability includes a conditional probability.

20. The method of claim 16, wherein selecting the additional categories is based on effective costs per mille (eCPM) values.

21. The method of claim 16, wherein the computer system electronically notifies a computer device of a publisher user of one or more additional categories which are recommended for the at least one publisher user to bid on, over the network.

22. The method of claim 15, wherein the computer system includes at least one server.

23. The method of claim 21, wherein each host computer device and the computer device of the publisher user includes at least one server.
